(19) United States
(12) Patent Application Publication
(10) Pub. No.: US 2013/0091066 A1
(43) Pub. Date: Apr. 11, 2013

(54) Compliance Survey on Mobile Device

(71) Applicants: Ying Zeng, Fremont, CA (US); Richard Choi, San Francisco, CA (US); Siriphat Oumtrakul, Mountain View, CA (US); Natharin Chanuntawaree, Mountain View, CA (US); Cheng Hu, Palo Alto, CA (US)

(72) Inventors: Ying Zeng, Fremont, CA (US); Richard Choi, San Francisco, CA (US); Siriphat Oumtrakul, Mountain View, CA (US); Natharin Chanuntawaree, Mountain View, CA (US); Cheng Hu, Palo Alto, CA (US)

(73) Assignee: SAP AG, Walldorf (DE)

(21) Appl. No.: 13/269,363

(22) Filed: Oct. 7, 2011

(51) Int. Cl. G06Q 99/00

(52) U.S. Cl. 705/317

(57) ABSTRACT

Survey processing for compliance assessment includes providing the survey to a mobile device. A survey application executing on the mobile device performs survey processing to obtain responses to survey questions comprising the survey. The survey application provides context-sensitive help information. The survey application provides for contacting individuals in a compliance management organization of a business enterprise for which compliance to regulations and policies by the business is required.

### BACKGROUND

The present invention relates to compliance with regulations and policies, and in particular to facilitating the compliance process using mobile devices.

Unless otherwise indicated herein, the approaches described in this section are not prior art to the claims in this application and are not admitted to be prior art by inclusion in this section.

In addition to the challenges posed due to a rapidly changing business environment and increasing competitive pressure, businesses around the world also face stronger regulative pressures. Regulations run the full gamut from employee protections, workplace safety, product quality, environmental protection, financial reporting, and so on. The number of regulations from various governing bodies, such as the government and within industries, continues to rise at a steady pace. Businesses have to invest a huge amount of resources/time to ensure they are in compliance with applicable regulations.

Large business enterprises often have a compliance management department to oversee the compliance process. Not only is the initial establishment of compliance important, but assuring that compliance is being maintained over time is equally important. Accordingly, controls are often defined to monitor compliance to the regulations. Periodic (e.g., annually, bi-annually, etc.) surveys are often used to assess these controls. However, it is often the case that the very people who need access to the central regulation compliance system do not have convenient access to the system, or are often in the places where such access is not always available. Consequently, responses to surveys and other questionnaires relating to the compliance process may not be available, thus making the compliance process incomplete and difficult to perform.

These and other issues are addressed by embodiments of the present invention, individually and collectively.

### SUMMARY

In embodiments, a mobile device may be configured to perform compliance processing including receiving a survey from a compliance management organization. A survey processing session is then conducted, including displaying a survey question from the survey on a display of the mobile device. An input graphic is displayed, along with first and second graphics. A response input from the user is sent to the compliance management organization. If the first graphic is selected, then auxiliary data (e.g., help information) related to the survey question may be displayed. If the second graphic is selected, then communication with an individual at the compliance management organization may be established.

In embodiments, the user may type in their response to a survey question, or the user may speak their response. The response may be sent to the compliance management organization as text or as a voice file. In some embodiments, a spoken response may be transcribed to text prior to sending to the compliance management organization.

In some embodiments, communication between the user and an individual at the compliance management organization may be with email or by texting. In other embodiments, the communication may be by phone or other interactive communication channel. Contact information for establishing communication with an individual at the compliance management organization may be included with the survey data sent from the compliance management organization. The auxiliary information may be included with the survey data sent from the compliance management organization.

Most employees and business users in an enterprise have access to mobile devices, whether a smart phone, a computer tablet, and so on. The use of mobile device to access compliance surveys and complete them can greatly expand the scope of survey recipients to many business users who may not always have access to a central regulation compliance system. Embodiments in accordance with the principles of the present invention can improve the quality of the survey response process and the effectiveness of the survey. It can also reduce the time needed to complete the survey.

The following detailed description and accompanying drawings provide a better understanding of the nature and advantages of the present invention.

### BRIEF DESCRIPTION OF THE DRAWINGS

FIG. 1 depicts a high level block diagram in accordance with embodiments of the present invention.

FIG. 2 is a flowchart for processing a compliance survey.

FIGS. 3A and 3B illustrate some examples of notification on a mobile device in accordance with disclosed embodiments.

FIGS. 4 and 4A are flowcharts for survey processing in accordance with aspects of the present invention.

FIG. 4B is a flowchart illustrating input processing in accordance with principles of the present invention.

FIG. 5 depict examples of a navigation screen and a session screen.

FIG. 6 depict examples of screens in accordance with the present invention.

FIG. 7 is a block diagram of a mobile device in accordance with disclosed embodiments.

### DETAILED DESCRIPTION

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

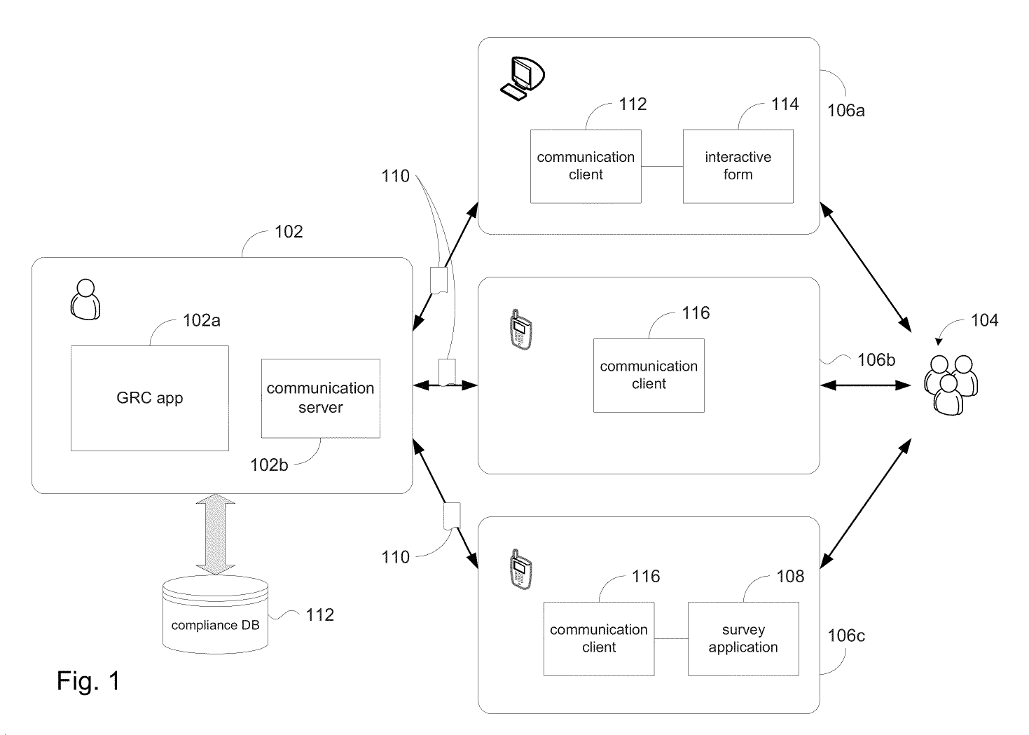

Referring to FIG. 1, a system 100 for compliance processing in accordance with embodiments of the present invention is shown. The system 100 may include a compliance management organization 102, including a compliance database 112 containing compliance-related data such surveys, users' responses to surveys, incident reports, notices, compliance documentation, and so on. Business users (employees) 104 of the business enterprise may work at desktop or laptop computers 106a. Some users 104 (sales personnel) may conduct much of their business using mobile devices 106b, 106c, such as smart phones, computer tablets (e.g., Apple® iPad® computer), and so on. In accordance with principles of the present invention, a mobile device 106c may include a survey application 108.

The compliance management organization 102 may manage aspects of the compliance process. The compliance management organization 102 may be affiliated with the business enterprise in any of a number of ways. In a large business enterprise, for example, the compliance management organization 102 may be an entire department within the enterprise. In a smaller enterprise, compliance management may be handled by an existing department. For example, the human resources department may double up it duties to include compliance management. Very small businesses may outsource their compliance management responsibilities, and so on.

Tasks of the compliance management organization 102 may include identifying applicable regulations and policies, identifying, and enacting processes for complying with the regulations and policies. Controls are usually defined to assess compliance with the regulations and policies. The task of control assessment typically includes monitoring the state of compliance and assessing whether there are potential or actual deviations from compliance that need to be addressed. The loop in the compliance management process is closed by taking subsequent action to address those deviations and thus maintain the enterprise's compliance with applicable regulations and policies.

The compliance management organization 102 may include some software component (e.g., a governance, risk, compliance (GRC) application) 102a to facilitate the compliance management process. A communication server 102b allows the compliance management organization 102 to communicate with the users 104 in order to manage compliance across the enterprise. Typically, surveys 110 comprising one or more survey questions are distributed to the users 104 for completion by the users.

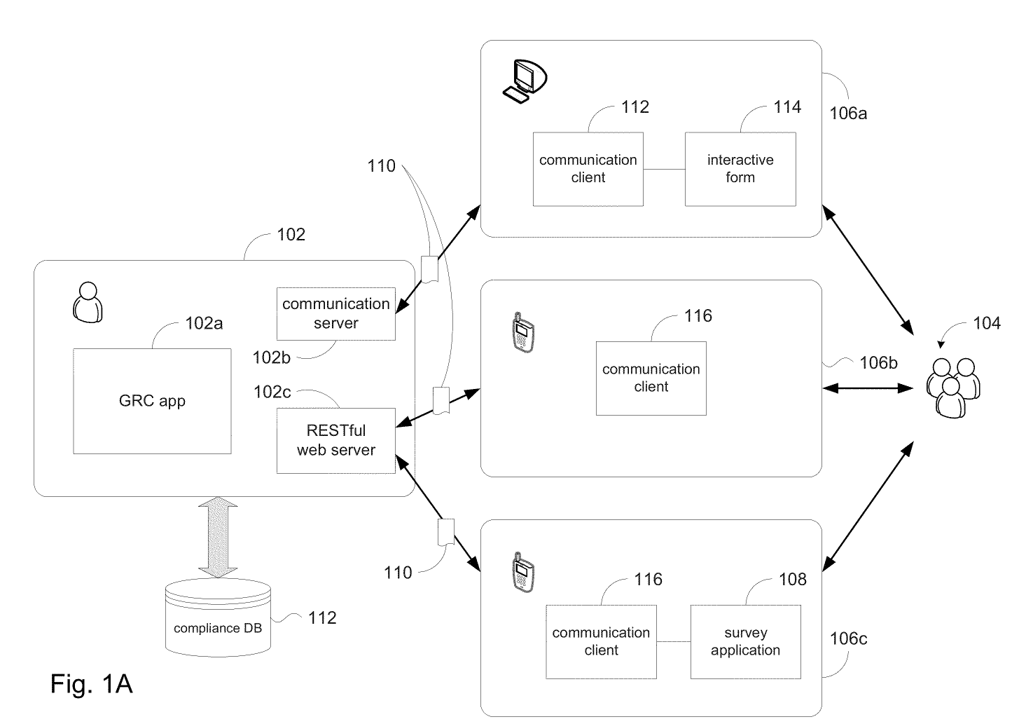

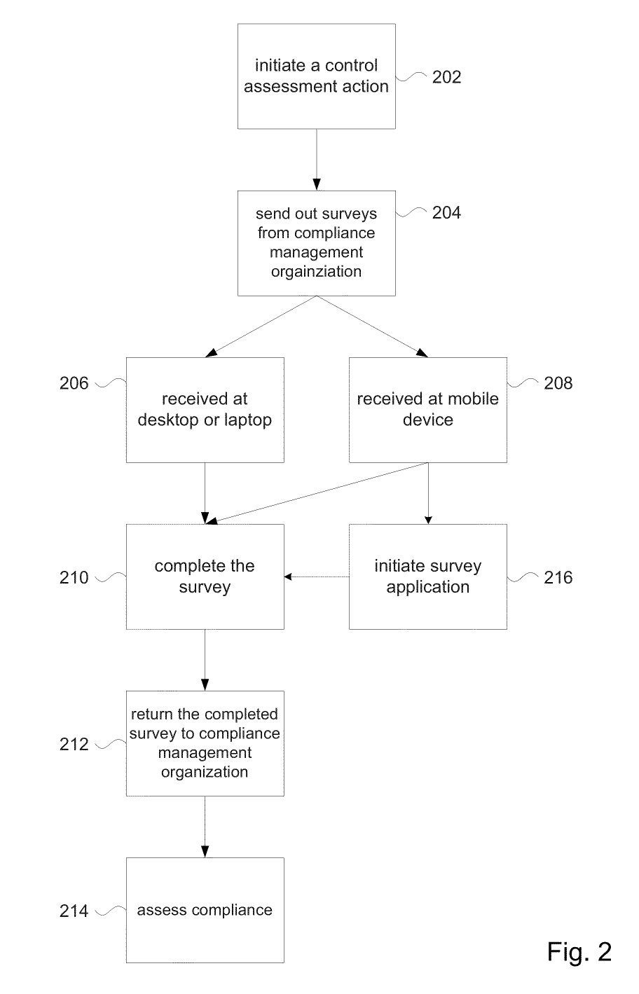

Referring to a flow chart shown in FIG. 2 with reference to FIG. 1, the task of control assessment typically involves making a survey across the various organizations and departments that comprise the business enterprise. Accordingly, at a step 202, an individual in the compliance management organization may trigger or otherwise initiate a “control assessment” action. In a step 204, the compliance management organization 102 may generate and send out one or more surveys 110 to various users 104 in the business enterprise. Each survey 110 may comprise a set of survey questions, designed to identify or otherwise assess issues or potential issues with compliance to regulations and policies applicable to the enterprise. Accordingly, one or more such surveys 110 may be generated.

The surveys 110 may be sent to users 104 at their desktop or laptop computers 106a, step 206. A survey 110 may be sent via email, for example, where a communication client 112 in the desktop or laptop computer 106a is an email client. In embodiments, the survey 110 may be attached in an email as an Adobe® interactive form 114 that can be filled out by the user. The survey 110 may be a text document or a formatted text document (e.g., Microsoft® Word® document) that can be opened and edited by the user 104. The survey 110 may be embedded in the email as an XML attachment, and so on.

In accordance with principles of the present invention, the users' mobile devices 106b, 106c may receive notification of a survey, in a step 208. In embodiments, the communication server 102b may be an email server, and communication clients 116 in the mobile devices 106b, 106c may be email clients, where the notification is notification of the receipt of an email from the compliance management organization 102. The survey 110 may be an attachment in an email sent from the compliance management organization 102 to the mobile device 106b. The attachment may be in any data format that is suitable for the receiving mobile device 106b, and may vary depending on the particular capabilities of the mobile device. For example, the attachment may be an XML file embedded in the email which can be opened in the survey application 108.

In embodiments, the compliance management organization 102 may employ a web service interface to handle interactions with a mobile device. The compliance management organization 102 may provide web services using Simple Object Access Protocol (SOAP), Web Services Description Language (WSDL), and the like. For example, the REpresentational State Transfer (REST) architecture is an increasingly common architecture for provisioning web services. Referring to FIG. 1A for a moment, in an embodiment, the compliance management organization 102 may include a RESTful web server 102c to manage the compliance database 112 and provide access to compliance survey 110 and, as will be discussed below, to any information relating to the compliance process. The web server 102c may provide POST'ing functions that allow an administrator in the compliance management organization 102 to define and otherwise manage compliance-related material in the compliance database 112.

Continuing with FIG. 2, in a step 210, the user completes the survey 110 by answering the survey questions, and in a step 212 returns a completed survey to the compliance management organization 102; e.g., by emailing the completed survey to the compliance management organization. In a step 214, the compliance management organization 102 may conduct its compliance assessment after receiving completed surveys from other users, and take appropriate corrective action if needed.

Returning to step 208, in accordance with principles of the present invention, the mobile device 106c may include a survey application 108 (FIG. 1) for processing the survey. In accordance with principles of the present invention, the mobile device 106c may receive notification in an email informing the user 104 that a survey 110 is pending for completion by the user. In other embodiments, the communication server 102b of the compliance management organization 102 may be a text messaging type of server, and the corresponding communication client 116 in the mobile device 106c may be text messaging receiver. The mobile device 106c may receive a text message from the compliance management organization 102 that a survey 110 is pending for completion by the user.

In a step 216, the user 104 may invoke the survey application 108 on their mobile device 106c. In some embodiments, the notification may include a link to the survey application 108 that invokes the application when the user 104 “taps” on the link. In other embodiments, the user 104 may directly access the survey application; e.g., by tapping on the application's icon displayed on the mobile device 106c. The process flow then proceeds as discussed above with step 210.

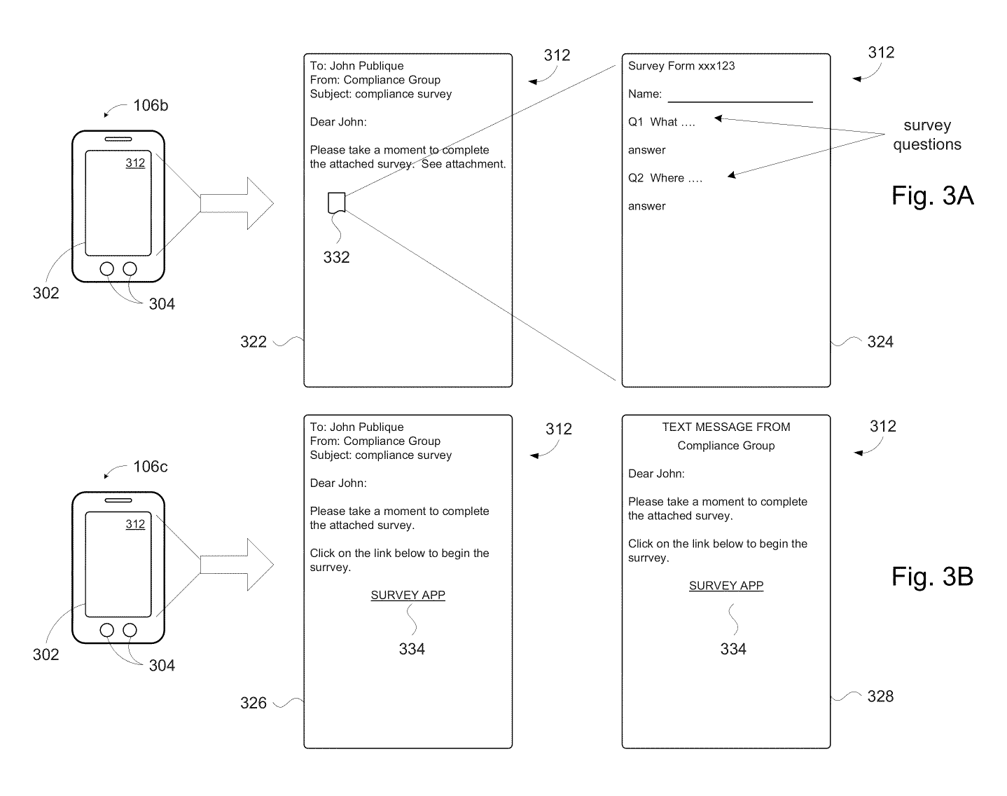

Referring to FIG. 3A, in some embodiments, the mobile device 106b typically includes a display area 302 and one or more function access buttons 304. The figure shows a display 312 of an email message 322 notifying a user (“John”) of a pending survey. In accordance with principles of the present invention, the email message 322 may include an icon 332 of an attachment which contains the survey. The user may “tap” on the icon 332 to open the attachment. FIG. 3A shows a display 312 of an example of a survey 324 contained in the attachment, comprising multiple survey questions (e.g., Q1, Q2) to be answered by the user.

In other embodiments, such as illustrated in FIG. 3B, the mobile device 106c includes survey application 108. A display 312 of an email message 326 may simply serve to notify the user of a survey to be completed. In accordance with principles of the present invention, the email message 326 may include a link 334 that is operative to invoke the survey application 108. In an embodiment, the notification may appear in a text message 328, also illustrated in FIG. 3B.

The text message 328 may also include a link 334 to invoke the survey application 108. In some embodiments, the link 334 may be omitted. The user may simply exit the email message 326 or text message 328, navigate to an icon in the mobile device 106c that represents the survey application 108, and invoke the survey application directly. Processing in the survey application 108 will now be discussed.

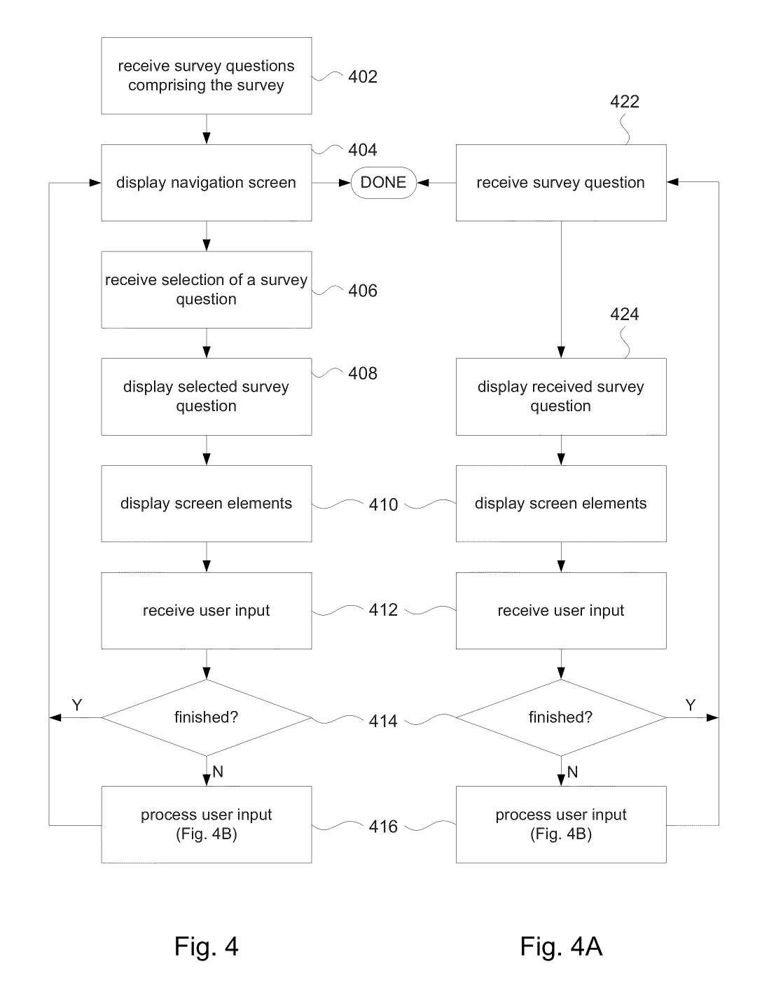

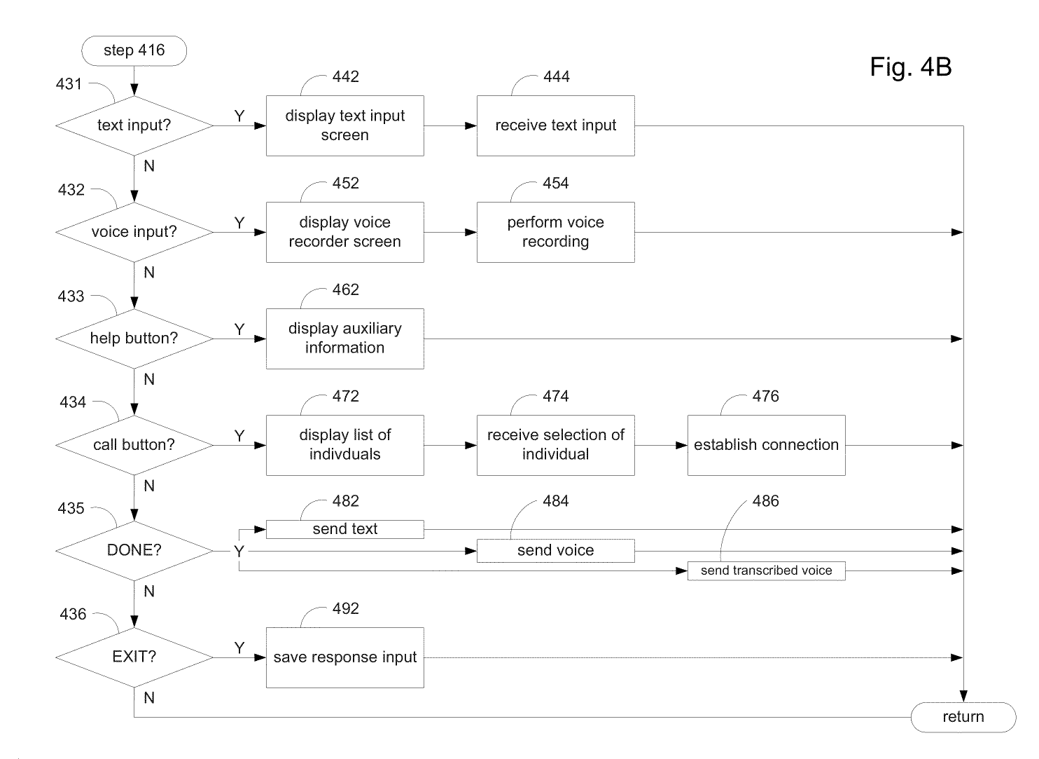

A flow chart shown in FIG. 4, illustrates processing in the survey application 108 in accordance with aspects of the present invention. When the survey application 108 is invoked, it will communicate with the compliance management organization 102 using the communication tools provided on the mobile device 106c to obtain data comprising the survey 110. The survey application 108 may present a startup screen to properly identify the user for security purposes for example. If the survey application 108 was invoked via a link 334 displayed in an email or text message, additional information that might be used to identify the user or the surveys may be provided via metadata associated with the email or text message. Otherwise, such additional information may be requested in the startup screen.

In a step 402, the survey application 108 receives from the compliance management organization 102 data that comprise the survey questions. The survey application 108 communicates with the compliance management organization 102 to download the survey questions of the survey 110 into the mobile device 106c. The entire survey may be downloaded, or portions of the survey may be downloaded one portion at a time and processed. For example, if the survey is large, it may be desirable to download a portion of the survey, process it, and the repeat the process with the next portion. For example, referring to the particular embodiment in FIG. 1C, the web service 102c may provide GET functionality in order to access survey questions from the compliance management organization 102 in response to requests from the mobile device 106c.

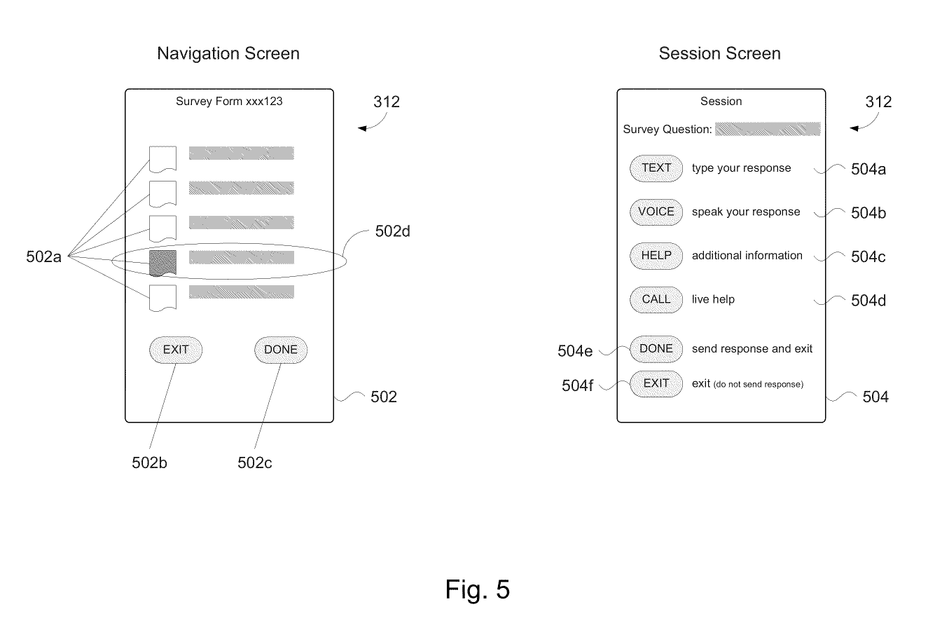

In a step 404, a navigation screen may be displayed that allows the user to select from among the survey questions that comprise the survey 110. For example, FIG. 5 shows an illustrative example of a display of a navigation screen 502. Each of the survey questions that comprise the survey may be represented by an icon 502a displayed in the display area 302 of the mobile device 106c (FIG. 3B). Each icon 502a may be displayed with some text that indicates the nature of the survey question. The user may tap an icon 502a to initiate a session to process the selected survey question. An EXIT button 502b may be displayed to allow the user to exit the survey application 108. A DONE button 502c may be displayed to allow the user to signal the survey application that the user has completed the survey 110.

In a step 406, when the user selects a survey question (e.g., by tapping one of the icons 502a), then a survey processing session may be initiated to process the selected survey question. A session screen may be displayed to support the survey processing session. Referring again to FIG. 5, an illustrative example of a session screen 504 is shown. The session screen 504 may include a display of the selected survey question (step 408) for the user's convenience.

Various display elements may be displayed (step 410). In some embodiments, the survey application may support multiple input modes. Accordingly, the session screen 504 may include a text input icon 504a and voice input icon 504b. Mobile device users may not have convenient access to individuals in the compliance management organizations. Therefore, in accordance with principles of the present invention, the survey application 108 may provide extensive support for the mobile device user. The session screen 504 may include a HELP button 504c and a CALL button 504d. These aspects of the present invention will be discussed in more detail below. A DONE button 504e may be provided to signal the survey application 108 that the user has responded to the survey question. An EXIT button 504f may be provided to allow the user to leave the session screen 504 without saving their response.

In a step 412, the survey application 108 receives input from the user. If the user has indicated (decision step 414) that they are done with the session screen (e.g., by having selected the DONE button 504e or the EXIT button 5040, then processing proceeds to step 404. Otherwise, the user input is processed in a step 416, which will be discussed in more detail in connection with FIG. 4B. When the user input is processed, the flow returns to step 404. In step 404, the navigation screen 502 is redisplayed. Survey questions that have been completed may be indicated in the display 312; e.g., survey question 502d.

Referring now to FIG. 4A for a moment, in some embodiments, the survey application 108 may receive a survey 110 from the compliance management organization 102, one survey question at a time. This may be desirable when it is not convenient to download the entire survey to the mobile device 106c; e.g., a very slow or unreliable connection between the mobile device and the compliance management organization 102 may result in limited communication bandwidth. Thus, in a step 422, the survey application 108 receives data that comprises a survey question. A survey processing session is initiated to process the received survey questions. Thus in a step 424 the received survey question is displayed in a session screen 504. Subsequent processing proceeds with steps 410-416 as discussed above.

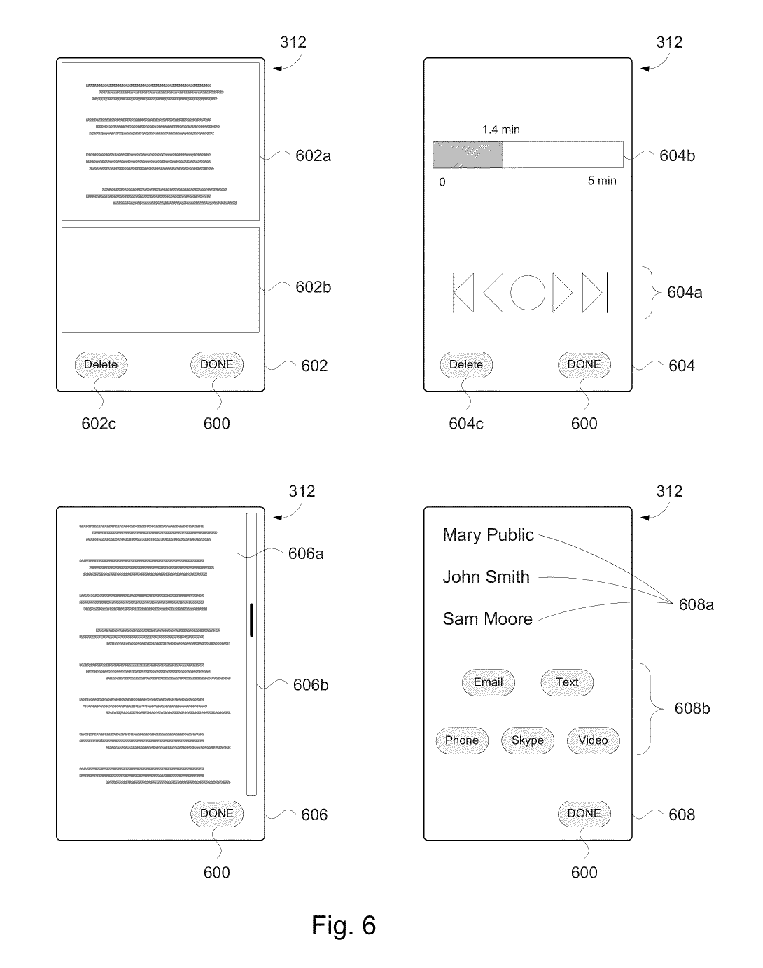

Processing of the user's input in step 416 in accordance with aspects of the present invention will now be discussed in connection with a flow chart shown in FIG. 4B with reference to the session screen 504 in FIG. 5. In a step 431, if it is determined that the user selected the TEXT button 504a, then in a step 442 a text input screen may be displayed. Referring to FIG. 6, for example, the display 312 shows a text input screen 602. An input window 602a displays text entered by the user. A virtual keyboard 602b may be provided to allow the user to type in text (step 444). In other embodiments, the mobile device 106c may have a physical keyboard for entering text. In other embodiments, a voice interface may allow the user to enter text into the input window 602a by speaking the text. A DELETE button 602c allows the user to delete whatever they input. A DONE button 600 allows the user to return to the session screen 504 display.

In a step 432, if it is determined that the user selected the VOICE button 504b, then in a step 452, a voice recorder screen may be displayed. Referring to FIG. 6, for example, a display 312 of a voice recorder screen 604 is shown. The voice recorder screen 604 may include standard record and playback controls 604a. The user may record (step 454) their response instead of typing it. A time indicator 604b may be provided to indicate the recording time. Still other recording controls may be provided. A DELETE button 604c allows the user to delete whatever they recorded. A DONE button 600 allows the user to return to the session screen 504 display.

In a step 433, if it is determined that the user selected the HELP button 504c, then in a step 462, a help screen may be displayed along with auxiliary information. FIG. 6 illustrates a display 312 of a help screen 606. A reading area 606a may display text and other graphics that comprise the auxiliary information. A scroll bar 606b allows the user to scroll the reading area 606a up and down. A DONE button 600 allows the user to return to the session screen 504 display.

In some embodiments, the help screen 606 provides context specific information. For example, the auxiliary information that is displayed may include information specific to the survey question being answered by the user. The auxiliary information may include any information relating to the survey question. For example, help information such as a definition of terms may be provided. Other help information such as an explanation of the survey question may be provided, and so on. The auxiliary information may identify sources of information about the subject matter of the survey, world wide web (WWW) links to web sites, and so on. In general, the auxiliary information may be any information that may assist the user in responding to the survey question. Referring back to FIG. 4, steps 402 and 432, recall that the survey application 108 receives from the compliance management system 102 data comprising the survey questions. In accordance with principles of the present invention, the survey application 108 may receive auxiliary information from the compliance management organization 102 associated with each survey question.

Returning to FIG. 4B, in a step 434, if it is determined that the user selected the CALL button 504d, then in a step 472, a call screen may be displayed. FIG. 6 shows a display 312 of a call screen 608. A list of individuals 608a is displayed, along with communication buttons 608b for communicating with an individual. In accordance with principles of the present invention, the call screen 608 allows the user to contact an individual 608a in the compliance management organization 102. The communication buttons 608b provide various options for communicating with an individual. For example, if the help screen 606 cannot address an issue about the survey question being answered by the user, the user may select an individual (step 474), for example, by taping on the name of the individual. An email or text with a more specific inquiry may then be sent (step 476) to the selected individual in the compliance management organization 102. The user may call an individual by phone, using Skype®, video conferencing or some other similarly interactive communication channel. A DONE button 600 allows the user to return to the session screen 504 display.

Referring back to FIG. 4, steps 402 and 432, recall that the survey application 108 receives from the compliance management system 102 data comprising the survey questions. In accordance with principles of the present invention, the survey application 108 may receive contact information from the compliance management organization 102 associated with each survey question, and which can then be displayed in the call screen 608. The contact information may vary from one survey question to the next, depending on the nature of the survey question. One or more individuals may be identified who are knowledgeable about the subject matter of the survey question. The contact information may include email address, telephone number, and other information that may be needed to establish communication with the individual. Additional information, such as available hours, and so on may be included.

Returning to FIG. 4B, in a step 435, if it is determined that the user selected the DONE button 504e, then the user's response may be sent to the compliance management organization 102. If the user typed their response, then the response may be sent to the compliance management organization 102 in text form; e.g., via email. If the use spoke their response (e.g., via voice screen 604, then the response may be sent to the compliance management organization 102 as a voice file. Alternatively, the spoken response may be transcribed and sent to the compliance management organization 102 as text. For example, referring to the particular embodiment in FIG. 1C, the web service 102c may provide suitable PUT functionality in order to communicate the user's response in the mobile device 106c to the compliance database 112.

In a step 436, if it is determined that the user selected the EXIT button 504f, then the user's response may be saved in a memory of the mobile device 106c, but not sent to the compliance management organization 102. Saving the response, but sending it allows the user to review and revise their response before sending. Alternatively, the response may be deleted if the user taps the EXIT button 504f.

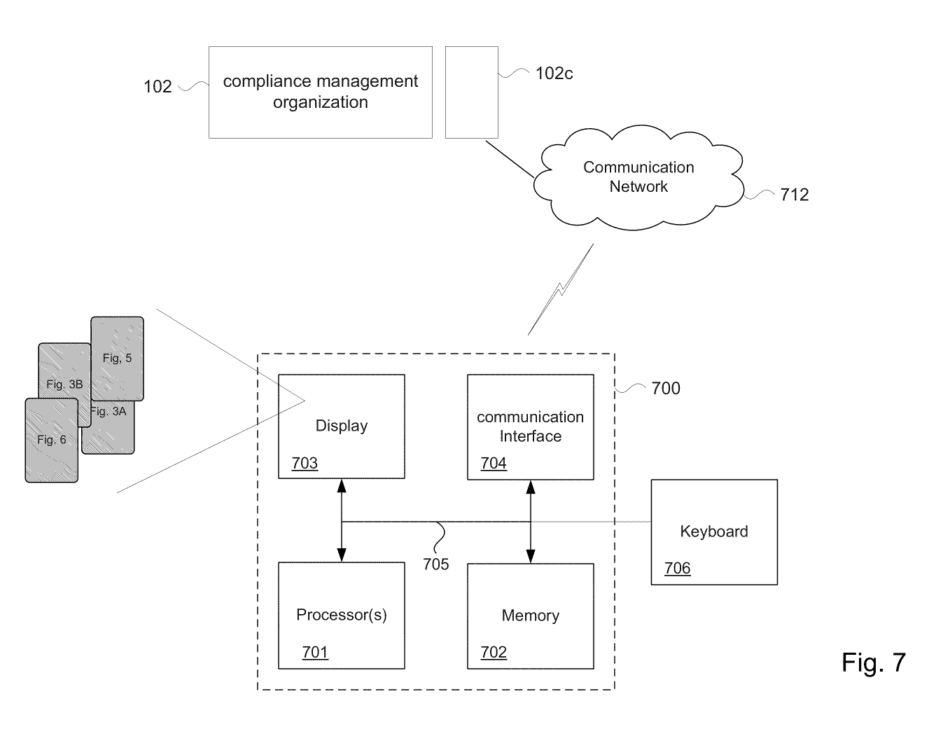

Referring to FIG. 7, in embodiments, a mobile device 700 can be configured to operate in accordance with aspects of the present invention. The mobile device 700 may comprise a data processor 701 and a memory component 702. The memory component 702 may comprise random access memory (usually volatile memory such as DRAM) and non-volatile memory such as FLASH memory, ROM, and so on. A display 703 may include a touch screen capability. A communication interface 704 provides voice and data communications over a communication network 712. A system of buses 705 can interconnect the foregoing subsystems, providing control lines, data lines, and/or voltage supply lines to/from the various subsystems. Some mobile devices employ a hardware keyboard 706, either as part of the mobile device or as an add on item (e.g., provided by third party suppliers). Other mobile devices provide a virtual keyboard that can be displayed on the display 703.

In embodiments, the memory component 702 includes various software stored in a non-volatile (non-transitory) part of the memory component, including for example the survey application 108. The survey application 108, when executed by the processor 701 results in the mobile device being a special purpose computer configured to perform the steps in accordance with the principles of the present invention and embodiments disclosed herein.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method in a mobile device for compliance processing, comprising the mobile device performing steps of:
receiving a notification message from a compliance management organization affiliated with a business, the notification message including invocation information to invoke survey processing relating to one or more regulations for which compliance by the business is required;
receiving from the compliance management organization a survey to be processed, the survey comprising data for one or more survey questions that comprise the survey; and
conducting a survey processing session including:
displaying a first survey question on a display component of the mobile device;
displaying an input graphic on the display component of the mobile device in order to receive a response input from a user;
displaying a first graphic on the display component of the mobile device;
displaying at least a second graphic on the display component of the mobile device;
in response to receiving a response input from the user, sending the response input to the compliance management organization;
in response to receiving input indicative of selection of the first graphic, displaying auxiliary data related to the survey question; and
in response to receiving input indicative of selection of the second graphic, communicating with the compliance management organization, including receiving a message from the user and sending the message to the compliance management organization.

2. The method of claim 1 further comprising receiving text from the user as the response input.

3. The method of claim 1 further comprising receiving a voice recording of the user as the response input.

4. The method of claim 3 wherein the step of sending the response input to the compliance management organization includes converting the voice recording to text data and sending the text data to the compliance management organization.

5. The method of claim 3 wherein the step of sending the response input to the compliance management organization includes sending the voice recording to the compliance management organization.

6. The method of claim 1 wherein the step of communicating includes sending the message from the user in an email or via text messaging.

7. The method of claim 1 wherein the step of communicating includes establishing a voice connection between the mobile device and an individual at the compliance management organization.

8. The method of claim 7 wherein the data for each of the survey questions includes information that identifies the individual at the compliance management organization.

9. The method of claim 1 wherein the data for each of the survey questions includes auxiliary information.

10. The method of claim 1 wherein the invocation information is operative to cause the mobile device to execute a compliance survey application to conduct the compliance processing session.

11. The method of claim 1 further comprising receiving from the compliance management organization data for a plurality of survey questions; and displaying a plurality of graphic images, wherein each graphic image represents one of the survey questions.

12. A mobile device comprising:
a processing component;
a memory;
a communication component; and
a display component,
the memory having stored thereon a computer executable program configured to operate the processor to perform steps of:
receiving from the communication component a notification message from a compliance management organization affiliated with a business, the notification message including invocation information to invoke survey processing relating to one or more regulations for which compliance by the business is required;
receiving from the communication component a survey sent from the compliance management organization, the survey comprising data for one or more survey questions that comprise the survey; and
conducting a survey processing session including:
displaying a first survey question on the display component;
displaying an input graphic on the display component in order to receive a response input from a user;
displaying a first graphic on the display component;
displaying at least a second graphic on the display component;
in response to receiving a response input from the user, sending the response input to the compliance management organization;
in response to receiving input indicative of selection of the first graphic, displaying auxiliary data related to the survey question; and
in response to receiving input indicative of selection of the second graphic, communicating with the compliance management organization, including receiving a message from the user and sending the message to the compliance management organization.

13. The mobile device of claim 12 wherein the computer executable program is further configured to operate the processor to perform a step of receiving a voice recording of the user as the response input.

14. The mobile device of claim 13 wherein the computer executable program is further configured to operate the processor to perform a step of sending the response input to the compliance management organization includes converting the voice recording to text data and sending the text data to the compliance management organization.

15. The mobile device of claim 13 wherein the step of sending the response input to the compliance management organization includes sending the voice recording to the compliance management organization.

16. The mobile device of claim 12 wherein the step of communicating includes sending the message from the user in an email or via text messaging.

17. The mobile device of claim 12 wherein the step of communicating includes establishing a voice connection between the mobile device and an individual at the compliance management organization.

18. The mobile device of claim 17 wherein the data for each of the survey questions includes information that identifies the individual at the compliance management organization.

19. A method for completing a compliance survey on a mobile device comprising:
receiving the compliance survey on the mobile device, the compliance survey relating to one or more regulations for which compliance by a business enterprise is required, the survey being sent from a compliance management organization affiliated with the business enterprise;
executing a survey completion program to obtain responses to survey questions that comprise the survey, the survey complete program causing the mobile device to:
display a first survey question on a display component of the mobile device;
display an input graphic on the display component in order to receive a response input from a user;
display a first graphic on the display component;
display at least a second graphic on the display component;
in response to receiving a response input from the user, send the response input to the compliance management organization;
in response to receiving input indicative of selection of the first graphic, display auxiliary data related to the survey question; and
in response to receiving input indicative of selection of the second graphic, communicate with the compliance management organization, including receiving a message from the user and sending the message to the compliance management organization.

20. The method of claim 19 wherein data for the survey includes, for each of the survey questions, information that identifies an individual at the compliance management organization.
